(19) United States
(12) Patent Application Publication
(10) Pub. No.: US 2017/0066995 A1
(43) Pub. Date: Mar. 9, 2017

(54) Method for Degumming And Esterification Of An Oil

(71) Applicant: BASF SE, Ludwigshafen (DE)

(72) Inventors: Joseph P. Borst, Plymouth, MI (US); Kenneth L. Zack, Wyandotte, MI (US); Michael G. Koch, Speyer (DE)

(21) Appl. No.: 15/123,489

(22) PCT Filed: Mar. 3, 2015
(86) PCT No.: PCT/US2015/018484

§ 371 Date: Sep. 2, 2016

Related U.S. Application Data
(60) Provisional application No. 61/947,780, filed on Mar. 4, 2014.

(51) Int. Cl. C11C 3/00; C11B 3/16; C11B 3/00

(52) U.S. Cl. CPC C11C 3/003; C11B 3/006; C11B 3/16

(57) ABSTRACT

A method for degumming and esterification of an oil comprising fatty acid glycerides, free fatty acids, and phospholipids comprises the steps of mixing the oil, a C1 to C5 monohydric alcohol, and methanesulfonic acid to form a reaction mixture, and heating the reaction mixture to esterify the free fatty acids and produce a fatty acid alkylester and water, and to degum the oil. The method further comprises the steps of causing a phase separation between a first phase comprising the C1 to C5 monohydric alcohol, phosphorous compounds, and water, a second phase comprising the fatty acid glycerides and the fatty acid alkylester, and a residual solid phase. Once the phase separation occurs, the second phase is separated from the first phase and the residual solid phase.

### FIELD OF THE INVENTION

The present disclosure generally relates to a method for degumming and esterification of an oil.

### DESCRIPTION OF THE RELATED ART

The transesterification of fatty acid glycerides yields fatty acid esters. Fatty acid esters are used in a wide array of commercial applications in pharmaceuticals, cosmetics, lubricants, plasticizers, hydraulic oils, and fuels.

Recently, fatty acid esters have emerged as a viable way to replace non-renewable energy sources with renewable energy sources. Specifically, fatty acid esters produced from renewable resources are particularly suitable as diesel fuel, i.e., “biodiesel”, and thus as a replacement for diesel fuel from non-renewable resources, e.g. fossil fuel.

In industry, biodiesel is typically obtained from oils and fats from renewable resources by means of a basic- or alkaline-catalytic transesterification process. Such fats and oils comprise fatty acid glycerides (triglycerides), free fatty acids, and gums comprising phospholipids (phosphotides). The transesterification process yields three “molecules of biodiesel” and one molecule of glycerol per molecule of fat or oil.

However, for the transesterification process to work efficiently, the oils and fats from renewable resources must be refined, i.e., the amount of free fatty acids in the fat or oil must be reduced or removed, and the oil degummed (the amount of phosphotides in the fat or oil must be reduced or removed). The free fatty acids are typically removed with an esterification process or by vacuum stripping, and the phosphotides are typically removed with a water wash process or a diluted aqueous acid wash process. These processes require that removal of the free fatty acids and the removal of the phosphotides be conducted in two distinct steps.

When the transesterification process is conducted with an oil or fat having a higher content of free fatty acids (e.g. greater than 0.5 parts by weight), the fatty acids react with the catalyst used in the transesterification process to form soaps and decrease the yield of fatty acid esters. Accordingly, to reduce catalyst use and increase yield, such oils and fats are typically esterified to reduce or remove the free fatty acids.

When the transesterification process is conducted with an oil or fat comprising phospholipids, clean phase separation between the glycerol and fatty acid ester is prevented. Accordingly, to increase yield, such oils and fats are degummed to breakdown or remove the phospholipids. Further, to meet the phosphorous and glycerol content requirements for biodiesel, such oils and fats must be degummed.

As such, there remains an opportunity to provide improved methods of degumming and removing free fatty acids from oils and fats, methods which are efficient and yield refined oil which can be effectively and efficiently used as feedstock for transesterification processes.

### SUMMARY OF THE INVENTION AND ADVANTAGES

The present disclosure provides a method for degumming and esterification of an oil comprising fatty acid glycerides, free fatty acids, and phospholipids. The method comprises the steps of mixing the oil, a C1 to C5 monohydric alcohol, and methanesulfonic acid to form a reaction mixture, heating the reaction mixture to esterify the free fatty acids and produce a fatty acid alkylester and water, and to degum the oil. The method further comprises the steps of causing a phase separation between a first phase comprising the C1 to C5 monohydric alcohol, phosphorous compounds, and water, a second phase comprising the fatty acid glycerides and the fatty acid alkylester, and a residual solid phase. Once the phase separation occurs, the second phase is separated from the first phase and the residual solid phase.

The method efficiently removes free fatty acid from the oil and degums the oil in a single efficient step.

### DETAILED DESCRIPTION OF THE INVENTION

A method for degumming and esterification of an oil comprising fatty acid glycerides, free fatty acids (“FFA”), and phospholipids is disclosed. The method is particularly efficient for replacing standard degumming and esterification processes. The method as described herein is conducted as a batch process. However, it should be appreciated that the steps of the method can be conducted in a continuous process. Further, the method can be conducted in a single reaction vessel or in multiple reaction vessels.

The method comprises the steps of mixing the oil, a C1 to C5 monohydric alcohol, and methanesulfonic acid (“MSA”) to form a reaction mixture, heating the reaction mixture to esterify the FFA and produce a fatty acid alkylester and water, and to degum the oil, i.e., remove or reduce the phospholipids. The method further comprises the steps of causing a phase separation between a first phase comprising the C1 to C5 monohydric alcohol, phosphorous compounds, and water, a second phase comprising the fatty acid glycerides and the fatty acid alkylester, and a residual solid phase. Once the phase separation occurs, the second phase is separated from the first phase and the residual solid phase.

As set forth above, the method comprises the step of mixing the oil, a C1 to C5 monohydric alcohol, and MSA to form a reaction mixture. The components are typically mixed in a reaction vessel such as a reactor, a barrel, a mixer, or the like.

The oil is typically selected from naturally occurring, unrefined vegetable and animal fats and oils. The oil can also comprise waste oils such as used deep fat fryer oil. Such oils comprise fatty acid glycerides (triglycerides), FFA, and gums comprising phospholipids (phosphotides). The oil typically comprises greater than 0.05, alternatively greater than 0.5, alternatively greater than 1.5, alternatively greater than 2.5, alternatively greater than 5.0, alternatively greater than 7.5, alternatively greater than 15, alternatively greater than 25, alternatively greater than 50, alternatively greater than 90, percent by weight FFA based on the total weight of the oil. The oil is typically selected from algae 1, algae 2, babassu oil, beef tallow, borage oil, camelina oil, canola oil, carob seed oil, castor oil, choice white grease, coconut oil, coffee, corn oil, evening primrose oil, fish oil, hemp oil, hepar oil, jatropha oil, jojoba oil, karanja oil, lesquerella fendlari oil, linseed oil, moringa oleifera oil, mustard oil, neem oil, palm oil, palm kernel oil, peanut oil, perilla seed oil, poultry fat, rapeseed oil, rice bran oil, soybean oil, stillingia oil, sunflower oil, tung oil, used cooking oil, yellow grease, vegetable oil, and combinations thereof.

The oil is typically present in the reaction mixture in an amount of from 50 to 98, alternatively from 60 to 95, alternatively from 70 to 90, percent by weight based on the total weight of the reaction mixture. The amount of the oil present in the reaction mixture may vary outside of the ranges above, but is typically both whole and fractional values within these ranges. Further, it is to be appreciated that the reaction mixture may include a combination of oils; in such a case, the total amount of all of the oils included in the reaction mixture is typically within the ranges above.

The C1 to C5 monohydric alcohol is a short-chain monohydric alcohol having 1 to 5 carbon atoms. The C1 to C5 monohydric alcohol is typically selected from methanol, ethanol, propanol, isopropanol, butanol, isobutanol, 3-methyl-1-butanol and neopentyl alcohol, and mixtures thereof. In various embodiments, the C1 to C5 monohydric alcohol comprises methanol and/or ethanol. In one embodiment, the C1 to C5 monohydric alcohol is ethanol. In a preferred embodiment, the C1 to C5 monohydric alcohol is methanol.

The C1 to C5 monohydric alcohol is typically present in the reaction mixture in an amount of from 2 to 50, alternatively from 5 to 45, alternatively from 10 to 40, percent by weight based on the total weight of the reaction mixture. The amount of the C1 to C5 monohydric alcohol present in the reaction mixture may vary outside of the ranges above, but is typically both whole and fractional values within these ranges. Further, it is to be appreciated that the reaction mixture may include a combination of C1 to C5 monohydric alcohols; in such a case, the total amount of all of the C1 to C5 monohydric alcohols included in the reaction mixture is typically within the ranges above.

The MSA can have various concentrations. Typically the MSA has a concentration of 70% or greater. In certain embodiments, the MSA is one which is formed by an air oxidation process, rather than from a chlorooxidation process. As such, the MSA has less metal content, such as less than 1 mg/kg, and little to no chloro compounds, which are generally corrosive. Non-limiting examples of suitable alkanesulfonic acids, for purposes of the present disclosure, are commercially available from BASF Corporation of Florham Park, N.J., under the trade name LUTROPUR®, such as LUTROPUR® MSA and LUTROPUR® MSA 100.

Suitable MSA is also described in U.S. Pat. No. 6,531,629 to Eiermann et al. and in U.S. Pat. App. Pub. No. 2008/0161591 to Richards, the disclosures of which are incorporated herein by reference in their entirety to the extent they do not conflict with the general scope of the present disclosure herein.

The MSA is a strong organic acid that is believed to be completely non-oxidizing and thermally stable. In addition, MSA has a low vapor pressure, has no odor, and is biodegradable. As such, the MSA is easy to handle and environmentally friendly, especially in comparison to strong acids known in the art such as sulfuric acid, nitric acid, and hydrochloric acid.

MSA is soluble in water and has a pKa of −1.9, which is greater than the pKa of the first stage of dissociation sulfuric acid (−3 for the first stage of dissociation, 1.9 for the second stage of dissociation). MSA has a lower corrosivity in comparison to sulfuric acid, nitric acid, hydrochloric acid, and does not act as an oxidizing and/or dehydrating agent. To this end, it is believed that use of MSA minimizes the corrosion of processing equipment.

Further, MSA is a significantly less strong sulfonation agent than sulfuric acid. Accordingly, emulsions and soap-like products are formed in a lower amount, and phase separation is faster and more efficient with MSA. Accordingly, the step of causing a phase separation, which is described further below, is conducted efficiently with MSA.

The MSA is typically present in the reaction mixture in an amount of from 0.1 to 3.0, alternatively from 0.1 to 2.0, alternatively from 0.1 to 1.5, alternatively from 0.1 to 1.0, percent by weight based on the total weight of the reaction mixture. The amount of the MSA present in the reaction mixture may vary outside of the ranges above, but is typically both whole and fractional values within these ranges.

The amounts of the oil, the C1 to C5 monohydric alcohol, and the MSA which are mixed, i.e., included in the reaction mixture, are described herein as a percent by weight based on the total weight of the reaction mixture. It is to be appreciated that the percent by weight of each component in the reaction mixture based on the total weight of the reaction mixture is calculated when the components are first mixed because the percentage of the components within the reaction mixture will change as chemical reactions progress.

In one embodiment, the reaction mixture is substantially free of water. That is, water is not added to the reaction mixture. Of course water is generated by various chemical reactions that do occur, such as the esterification of the FFA which produces fatty acid alkylesters and water. In other embodiments, the reaction mixture is substantially free to completely free of acids other than MSA, e.g. hydrochloric acid, sulfuric acid, phosphoric acid, etc.

The method also includes the step of heating the reaction mixture to esterify the free fatty acids and produce a fatty acid alkylester and water, and to degum the phospholipids. Of course the steps of mixing and heating can occur in sequence or can occur simultaneously.

The esterification of the FFA occurs when the FFA reacts with the C1 to C5 monohydric alcohol in the presence of the MSA to produce a fatty acid alkylester and water. In embodiments where the C1 to C5 monohydric alcohol comprises methanol, the fatty acid alkylester produced comprises a fatty acid methylester.

The step of heating is typically conducted simultaneous with the step of mixing. That is, the reaction mixture is typically heated while being mixed in a reaction vessel. The reaction mixture is typically heated to a temperature of from 20 to 80, alternatively from 30 to 65,° C. Further, the step of heating is typically conducted in from 80 to 200 minutes, alternatively less than 200, alternatively less than 150, alternatively less than 120, minutes. In a preferred embodiment, the step of heating is further defined as refluxing the reaction mixture.

As set forth above, during the step of heating, the FFA is esterified to produce a fatty acid alkylester and water, and to degum the oil, i.e., remove or reduce the phospholipids. During the degumming process, the phospholipids are believed to be broken down and/or separated from the fatty acid glycerides and the fatty acid alkylester. To this end, the step of heating is believed to separate and degrade the phospholipids (phosphotides) and produce phosphorous compounds. Phosphorous compounds are defined, for purposes of the subject disclosure, as phospholipids and the reaction products thereof (e.g. decomposition products of the phospholipids, hydrated phospholipids, etc.) As such, the method of the subject invention does not require a step of washing the oil with water to degum the oil.

In another embodiment step of heating can be conducted at atmospheric pressure at greater than 100, alternatively greater than 110, alternatively greater than 120,° C. with the continuous addition and stripping of a monohydric alcohol and water. Alternatively, the step of heating can be conducted at greater than atmospheric pressure in a closed system and at temperatures greater than 75, alternatively greater than 100, alternatively greater than 125,° C. in the presence of a monohydric alcohol.

While processes described are batch processes, the step of heating can be conducted in a continuous process, and continuous processes are also contemplated herein.

In the method of the subject disclosure, the simultaneous degumming and FFA reduction with methanol and MSA makes the addition of water optional. To this end, various embodiments of the method are free of rinsing the reaction mixture and/or the phases formed therefrom with water. Said differently, the steps of mixing, heating, and causing a phase separation are free of any additional water or water rinses in various embodiments of the method, and various embodiments of the method are free of the step of mixing the oil (or reaction product thereof) with water.

The method also includes the step of causing a phase separation between:
(1) the first phase comprising the C1 to C5 monohydric alcohol, phosphorous compounds, and water,
(2) the second phase comprising the fatty acid glycerides and the fatty acid alkylester, and
(3) the residual solid phase.

The step of causing a phase separation is typically conducted via centrifugation. If centrifugation is employed, the centrifugation is typically conducted in less than 120, alternatively less than 60, alternatively less than 30, minutes.

Once the phase separation occurs, the second phase is separated from the first phase and the residual solid phase. At this juncture, the second phase can be washed with water. If the second phase is washed with water, the washing is typically conducted with water having a temperature of from 20 to 50° C.

In one embodiment of the method, the steps of mixing, heating, causing a phase separation, and separating, are repeated with the separated second phase (rather than the oil). In such an embodiment, the oil typically comprises significant amounts of FFA and phospholipids to start with and therefore may still comprise enough FFA and phospholipids after a first degumming and esterification process to require an additional degumming and esterification process. Alternatively, the end use of the mixture of fatty acid glycerides and the fatty acid alkylesters may simply require minimal amounts of FFA and phospholipids. As such, one particular embodiment of the method includes the additional steps of: mixing the separated second phase, the C1 to C5 monohydric alcohol, and MSA to form a second reaction mixture; heating the second reaction mixture to esterify the remaining FFA and to produce the fatty acid alkylester and water, and to degum the remaining phospholipids; causing a phase separation between a third phase comprising the C1 to C5 monohydric alcohol, phosphorous compounds, and water, a fourth phase comprising the fatty acid glycerides and the fatty acid alkylester, and a second residual solid phase; and separating the third phase from the fourth phase.

Further, it should be appreciated that the various steps of the method can be conducted once, or multiple times, i.e., as a single step or in multiple sub-steps. For example, the reaction can be first mixed via mechanical stirring, and then mixed during the step of heating, e.g. during refluxing.

The method of the subject disclosure effectively esterifies the FFA and degums the phospholipids of the oil. To this end the second phase (the refined oil) typically comprises less than 60, alternatively less than 50, alternatively less than 40, alternatively less than 30, alternatively less than 20, alternatively less than 10, alternatively less than 5 percent by weight of the total weight of FFA which was originally present in the oil. For example, for less than 10 percent by weight, if the oil includes 10 percent by weight FFA, the second phase typically includes less than 1 percent FFA. Further, the second phase (refined oil) typically comprises less than 60, alternatively less than 50, alternatively less than 40, alternatively less than 30, alternatively less than 20, alternatively less than 10, alternatively less than 5, percent by weight of the total weight of phosphorous which was originally present in the oil. For example, for less than 10 percent by weight, if the oil includes 500 ppm phosphorous, the second phase typically includes less than 50 ppm phosphorous.

In various embodiments, the method further comprises the steps of transesterifying the second phase and/or the fourth phase to obtain biodiesel from the oil via a basic- or alkaline-catalytic transesterification process. In such a process the fatty acid glycerides (triglycerides) of the refined oil of the second and/or fourth phase yields three “molecules of biodiesel” and one molecule of glycerol per molecule of fatty acid glyceride. These steps are particularly efficient because the amount of free fatty acids in the feedstock (i.e., the refined oil of the second and/or the fourth phase is minimal, and the feedstock is degummed (the amount of phosphotides in the fat or oil minimal). Suitable steps for completing the transesterification are described in U.S. Pat. App. Pub. No. 2011/0245521 to Fassbender, the disclosure of which is incorporated herein by reference in its entirety to the extent that it does not conflict with the general scope of the present disclosure herein.

Accordingly, in various embodiments, the method further comprises the steps of: transesterifying the second phase or the fourth phase with the C1 to C5 monohydric alcohol (as it is described above) in the presence of at least one basic catalyst to form a transesterification mixture comprising a fatty acid alkylester and glycerine; and treating the transesterification mixture with a strong acid such as sulfuric acid and/or MSA. This embodiment can further include the step of phase separating the fatty acid alkylester and the glycerine subsequent to the step of transesterifying, but prior to the step of treating the transesterification mixture with sulfuric acid and/or MSA.

When the method further comprises the steps of transesterifying the second phase and/or the fourth phase to obtain biodiesel, a basic- or alkaline-catalytic transesterification process with a basic catalyst typically selected from at least one basic alkali metal or alkaline earth metal compound selected from the group of sodium hydroxide, potassium hydroxide, a sodium alkoxide of the short-chain monohydric alcohol having 1 to 5 carbon atoms, a potassium alkoxide of the short-chain monohydric alcohol having 1 to 5 carbon atoms, and combinations thereof.

The following examples, illustrating the method of the present disclosure, are intended to illustrate and not to limit the disclosure.

### EXAMPLES

Examples 1-15 are oils which are degummed and esterified in accordance with the method of the subject disclosure. Comparative Examples 1-9 are oils which are degummed and esterified by methods which are not in accordance with the method of the subject disclosure, but are set forth for comparative purposes.

In Examples 1-10, Oil A is simultaneously degummed (phospholipids are removed) and esterified (FFA is removed). Oil A is undegummed and includes 90% by weight soy oil and 10% by weight oleic acid. As such, Oil A comprises 981 ppm phosphorous and 9.31% by weight FFA. Referring now to Table 1, the methods of Examples 1-10 include the step of mixing Oil A, methanol (a C1 to C5 monohydric alcohol), and MSA (100%) to form a reaction mixture. The amounts of Oil A, methanol, and MSA are set forth in Table 1 below. Once formed, each respective reaction mixture is heated in accordance with the time and temperature parameters set forth in Table 1 below. During the step of heating, FFA is esterified to produce a fatty acid alkylester and water, and the oil is degummed. After the step of heating, the reaction mixture can optionally be rinsed with water. After the step of heating, each respective reaction mixture is centrifuged and a phase separation occurs between a first phase comprising the methanol, phosphorous compounds, and water, a second phase comprising the fatty acid glycerides and the fatty acid alkylester, and a residual solid phase. Once the phase separation occurs, the second phase is separated from the first phase and the residual solid phase, to yield samples of Oil A which are degummed (have phospholipids removed therefrom) and are also esterified (have FFA removed therefrom).

Comparative Examples 1-6 are made in accordance with the steps in the preceding paragraph, with the amounts and process parameters used to make these Comparative Examples also set forth in Table 1.

TABLE 1

| | | | Acid | | | | % H₂0 |
|---|---|---|---|---|---|---|---|
| | Oil A | Methanol | Type | Heating | Phase | Sep. | After |
| | (g) | (g) | Amt. (g) | (min/° C.) | Sep. | Washing | Wash |
| Example 1 | 100 | 50 | MSA | 180/60 | Centrifuge | — | 0.00 |
| | | | 1.2 | | | | |
| Example 2 | 100 | 50 | MSA | 180/60 | Centrifuge | Water | 1.00 |
| | | | 1.2 | | | 25° C. | |
| Example 3 | 100 | 50 | MSA | 180/60 | Centrifuge | — | 0.00 |
| | | | 1.2 | | | | |
| Example 4 | 100 | 50 | MSA | 90/60 | Centrifuge | Water | 1.00 |
| | | | 1.2 | | | 25° C. | |
| Example 5 | 100 | 30 | MSA | 135/60 | Centrifuge | — | 0.00 |
| | | | 0.9 | | | | |
| Example 6 | 100 | 10 | MSA | 90/60 | Centrifuge | — | 0.00 |
| | | | 1.2 | | | | |
| Example 7 | 100 | 50 | MSA | 90/60 | Centrifuge | — | 0.00 |
| | | | 0.6 | | | | |
| Example 8 | 100 | 50 | MSA | 180/60 | Centrifuge | — | 0.00 |
| | | | 0.6 | | | | |
| Example 9 | 100 | 50 | MSA | 120/60 | Centrifuge | — | 0.00 |
| | | | 0.6 | | | | |
| Example 10 | 100 | 10 | MSA | 180/60 | Centrifuge | — | 0.00 |
| | | | 0.6 | | | | |
| Comparative | 100 | 0 | MSA | 90/60 | Centrifuge | Water | 1.00 |
| Example 1 | | | 1.2 | | | 25° C. | |
| Comparative | 100 | 0 | MSA | 90/60 | Centrifuge | — | 0.00 |
| Example 2 | | | 1.2 | | | | |
| Comparative | 100 | 50 | 0 | 90/60 | Centrifuge | — | 0.00 |
| Example 3 | | | | | | | |
| Comparative | 100 | 50 | 0 | 90/60 | Centrifuge | Water | 1.00 |
| Example 4 | | | | | | 25° C. | |
| Comparative | 100 | 50 | H₃PO₄ | 120/60 | Centrifuge | — | 0.00 |
| Example 5 | | | 0.72 | | | | |
| Comparative | 100 | 50 | H₂SO₄ | 120/60 | Centrifuge | — | 0.00 |
| Example 6 | | | 0.62 | | | | |
| Control A | 100 | — | — | — | — | — | — |

Once formed, the degummed and esterified oils of Examples 1-10 and Comparative Examples 1-6 are analyzed for Ca, K, Mg, Na, S, P, and FFA content. The results of the analytical testing are set forth in Table 2 below.

TABLE 2

| | Ca | K | Mg | Na | S | P | % |
|---|---|---|---|---|---|---|---|
| | (ppm) | (ppm) | (ppm) | (ppm) | (ppm) | (ppm) | FFA |
| Example 1 | 0 | 0 | 0 | 0 | 73 | 17 | 0.27 |
| Example 2 | 0 | 0 | 0 | 4 | 69 | 18 | 0.27 |
| Example 3 | 0 | 0 | 0 | 2 | 98 | 36 | 0.16 |
| Example 4 | 0 | 0 | 0 | 3 | 68 | 48 | — |
| Example 5 | 0 | 0 | 0 | 2 | 124 | 77 | 0.32 |
| Example 6 | 0 | 3 | 0 | 2 | 207 | 78 | 0.65 |
| Example 7 | 0 | 0 | 0 | 2 | 67 | 93 | 0.15 |
| Example 8 | 0 | 3 | 0.3 | 2 | 107 | 99 | 0.24 |
| Example 9 | 2 | 0 | 0 | 2 | 82 | 105 | 0.22 |
| Example 10 | 1 | 3 | 0 | 2 | 147 | 140 | 0.88 |
| Comparative | 0 | 0 | 0 | 1 | 572 | 210 | 13.39 |
| Example 1 | | | | | | | |
| Comparative | 0 | 0 | 0 | 0 | 2167 | 213 | 15.93 |
| Example 2 | | | | | | | |
| Comparative | 32 | 68 | 33 | 0 | 15 | 378 | 7.55 |
| Example 3 | | | | | | | |
| Comparative | 35 | 71 | 35 | 2 | 15 | 460 | 8.30 |
| Example 4 | | | | | | | |
| Comparative | 48 | 54 | 40 | 2 | 10 | 668 | 8.14 |
| Example 5 | | | | | | | |
| Comparative | 13 | 5 | 0.4 | 4 | 71 | 112 | 0.29 |
| Example 6 | | | | | | | |
| Control A | 33 | 199 | 38 | 2 | 15 | 981 | 9.31 |

Referring now to Table 2, Examples 1-10 include significantly reduced amounts of phosphorous and FFA when compared to Oil A (Control A), i.e., the oil of Examples 1-10 is effectively degummed and esterified (phosphorus and FFA levels reduced) with the method of the subject disclosure. Examples 1 and 3, which utilize 1.2 grams of MSA and 50 grams of methanol (per 100 grams of oil) and are reacted for 180 minutes at a temperature of 60° C., were particularly effective for the simultaneous reduction of phosphorus and FFA.

Still referring to Table 2, Comparative Examples 1 and 2, which include MSA, but do not include methanol in the step of mixing, demonstrate relatively high levels of phosphorous and FFA. Comparative Examples 3 and 4, which do not include MSA, but do include methanol in the step of mixing, also demonstrate relatively high levels of phosphorous and FFA. In contrast to Comparative Examples 1-4, Examples 6 and 7, which include both MSA and methanol in the step of mixing and are otherwise produced with similar process parameters, demonstrate relatively low levels of phosphorous and FFA, i.e., the refined oil of Examples 6 and 7 are effectively degummed and esterified.

Referring now to Examples 1 and 2 of Tables 1 and 2, the method of Example 1 does not include the step of washing the oil or a reaction product thereof with water, and Example 2 does include the step of washing the oil or a reaction product thereof with water. Nonetheless, Example 1 includes significantly reduced amounts of phosphorous and FFA when compared to Oil A (Control A), and the oil of Example 1 is comparable to the oil of Example 2, which includes the extra step of washing the oil or a reaction product thereof with water.

Further, in Example 9 and Comparative Examples 5 and 6 of Tables 1 and 2, the effectiveness of MSA in the method is compared to the effectiveness of sulfuric and phosphoric acid. MSA and sulfuric acid were effective in the simultaneous degumming and esterification (FFA reduction), but phosphoric acid is not.

Referring now to Table 3, in Examples 11-14, Oil B is simultaneously degummed (phospholipids are removed) and esterified (FFA is removed). Oil B is undegummed soy oil. Oil B comprises 1079 ppm phosphorous and about 0.1% by weight FFA. Referring now to Table 3, the methods of Examples 11-14 include the step of mixing Oil B, methanol (a C1 to C5 monohydric alcohol), and MSA (100%) to form a reaction mixture. The amounts of Oil B, methanol, and MSA are set forth in Table 3 below. Once formed, each respective reaction mixture is heated in accordance with the time and temperature parameters set forth in Table 3 below. During the step of heating, FFA is esterified to produce a fatty acid alkylester and water, and the oil is degummed After the step of heating, the reaction mixture can optionally be rinsed with water. After the step of heating, each respective reaction mixture is centrifuged and a phase separation occurs between a first phase comprising the methanol, phosphorous compounds, and water, a second phase comprising the fatty acid glycerides and the fatty acid alkylester, and a residual solid phase. Once the phase separation occurs, the second phase is separated from the first phase and the residual solid phase, to yield samples of Oil B which are degummed (have phospholipids removed therefrom) and are also esterified (have FFA removed therefrom).

Comparative Examples 7 and 8 are made in accordance with the steps in the preceding paragraph, with the amounts and process parameters used to make these Comparative Examples also set forth in Table 3.

TABLE 3

| | | | Acid | | | | |
|---|---|---|---|---|---|---|---|
| | | | Type & | | | | % H₂0 |
| | Oil B | Methanol | Amount | Heating | Phase | Sep. | After |
| | (g) | (g) | (g) | (min/° C.) | Sep. | Washing | Wash |
| Example 11 | 100 | 50 | MSA | 90/25 | Centrifuge | — | 0.00 |
| | | | 1.2 | | | | |
| Example 12 | 100 | 50 | MSA | 90/25 | Centrifuge | Water | 1.00 |
| | | | 1.2 | | | 25° C. | |
| Example 13 | 100 | 50 | MSA | 90/60 | Centrifuge | — | 0.00 |
| | | | 1.2 | | | | |
| Example 14 | 100 | 50 | MSA | 90/60 | Centrifuge | Water | 1.00 |
| | | | 1.2 | | | 25° C. | |
| Comparative | 100 | 0 | MSA | 7/25 | Centrifuge | — | 0.00 |
| Example 7 | | | 1.2 | | | | |
| Comparative | 100 | 0 | MSA | 7/25 | Centrifuge | Water | 1.00 |
| Example 8 | | | 1.2 | | | 25° C. | |
| Control B | 500 | — | — | — | — | — | — |
| | Ca | K | Mg | Na | S | P | % |
| | (ppm) | (ppm) | (ppm) | (ppm) | (ppm) | (ppm) | FFA |
| Example 11 | 1 | 3 | 0.3 | 1 | 79 | 92 | — |
| Example 12 | 1.4 | 3 | 0.9 | 1 | 75 | 115 | — |
| Example 13 | 2 | 3 | 0.4 | 2 | 118 | 23 | — |
| Example 14 | 0 | 0 | 0 | 1 | 68 | 12 | — |
| Comparative | 1 | 3 | 2 | 0 | 949 | 114 | — |
| Example 7 | | | | | | | |
| Comparative | 0.9 | 3 | 0.3 | 1 | 311 | 27 | — |
| Example 8 | | | | | | | |
| Control B | — | — | — | — | — | 1079 | about |
| | | | | | | | 0.1 |

Referring now to Table 3, Examples 11-14 include significantly reduced amounts of phosphorous compared to Oil B (Control B), i.e., the oil of Examples 11-14 are effectively degummed (phosphorus removed) with the method of the subject disclosure (with and without the water wash step). Examples 11 and 13, which utilize 1.2 grams of MSA and 50 grams of methanol (per 100 grams of oil), and are reacted for 90 minutes at a temperature of 60° C. were particularly effective for degumming—with no water wash.

Referring now to Table 4, with respect to Example 15, Oil C is simultaneously degummed (phospholipids are removed) and esterified (FFA is removed). Oil C is rapeseed oil. Oil C includes 39 ppm phosphorous and 10% by weight FFA. Referring now to Table 4, the method of Example 15 includes the step of mixing Oil C, methanol, and MSA to form a reaction mixture. The amounts of Oil C, methanol, and MSA are set forth in Table 4 below. Once formed, the reaction mixture is heated in accordance with the time and temperature parameters set forth in Table 4 below. During the step of heating, FFA is esterified to produce a fatty acid alkylester and water, and the phospholipids are degummed After the step of heating, the reaction mixture can optionally be rinsed with water. After the step of heating, the reaction mixture is centrifuged and a phase separation occurs between a first phase comprising the methanol, phosphorous compounds, and water, a second phase comprising the fatty acid glycerides and the fatty acid alkylester, and a residual solid phase. Once the phase separation occurs, the second phase is separated from the first phase and the residual solid phase to form Oil C which is degummed (has phospholipids removed therefrom) and is also esterified (has FFA removed therefrom).

Comparative Example 9 is made in accordance with the steps in the preceding paragraph, with the amounts and process parameters used to make this Comparative Example also set forth in Table 4.

Once formed, the degummed and esterified oil of Example 15 and Comparative Example 9 are analyzed for Ca, K, Mg, Na, S, P, and FFA content. The results of the analytical testing are also set forth in Table 4 below.

TABLE 4

| | | | Acid | | | | |
|---|---|---|---|---|---|---|---|
| | | | Type & | | | | % H₂0 |
| | Oil C | Methanol | Amount | Heating | Phase | Sep. | After |
| | (g) | (g) | (g) | (min/° C.) | Sep. | Washing | Wash |
| Example 15 | 500 | 50 | MSA | 150/72 | Centrifuge | Water | 5.00 |
| | | | (70%) | | | 25° C. | |
| | | | 1.2 | | | | |
| Comparative | 500 | 50 | H₂SO₄ | 150/72 | Centrifuge | Water | 5.00 |
| Example 9 | | | (96%) | | | 25° C. | |
| | | | 1.2 | | | | |
| Control C | 500 | — | — | — | — | — | — |
| | Ca | K | Mg | Na | S | P | % |
| | (ppm) | (ppm) | (ppm) | (ppm) | (ppm) | (ppm) | FFA |
| Example 15 | <2 | — | <2 | — | 270 | 6.1 | 3.00 |
| Comparative | 2.1 | — | <2 | — | 117 | 3.3 | 1.50 |
| Example 9 | | | | | | | |
| Control C | — | — | — | — | — | 39 | 10.00 |

Referring now to Table 4, Example 15 which utilizes MSA includes comparable amounts of phosphorous and FFA to Comparative Example 9 which utilizes sulfuric acid. Further, Example 15 includes significantly reduced amounts of phosphorous and FFA when compared to undegummed Oil C (Control C), i.e., the oil of Example 15 is effectively degummed and esterified with the method of the subject disclosure.

Example 16 is an oil which is degummed and esterified in accordance with the method of the subject disclosure. Comparative Example 10 is an oil which is degummed and esterified by methods which are not in accordance with the method of the subject disclosure, but is set forth for comparative purposes.

In Example 16, Oil D is simultaneously degummed (phospholipids are removed) and esterified (FFA is removed). Oil D is undegummed tallow. As such, Oil D comprises 190 ppm phosphorous and 4.09% by weight FFA. Referring now to Table 5, the method of Example 16 includes the step of mixing Oil D, methanol (a C1 to C5 monohydric alcohol), and MSA (100%) to form a reaction mixture. The amount of Oil D, methanol, and MSA are set forth in Table 5 below. Once formed, the reaction mixture is heated in accordance with the time and temperature parameters set forth in Table 5 below. During the step of heating, FFA is esterified to produce a fatty acid alkylester and water, and the oil is degummed After the step of heating, the reaction mixture can optionally be rinsed with water. After the step of heating, each respective reaction mixture is centrifuged and a phase separation occurs between a first phase comprising the methanol, phosphorous compounds, and water, a second phase comprising the fatty acid glycerides and the fatty acid alkylester, and a residual solid phase. Once the phase separation occurs, the second phase is separated from the first phase and the residual solid phase, to yield a sample of Oil D which is degummed (has phospholipids removed therefrom) and is also esterified (has FFA removed therefrom). Comparative Example 10 is made in accordance with the steps described immediately above, with the amounts and process parameters used to make Comparative Example 10 also set forth in Table 5.

Once formed, the degummed and esterified oil of Example 16 and Comparative Example 10 are analyzed for Ca, K, Mg, Na, S, P, and FFA content. The results of the analytical testing are also set forth in Table 5.

TABLE 5

| | | | Acid | | | | |
|---|---|---|---|---|---|---|---|
| | | | Type & | | | | % H₂0 |
| | Oil D | Methanol | Amount | Heating | Phase | Sep. | After |
| | (g) | (g) | (g) | (min/° C.) | Sep. | Washing | Wash |
| Example 16 | 100 | 50 | MSA | 90/60 | Centrifuge | — | 5.00 |
| | | | (100%) | | | | |
| | | | 0.3 | | | | |
| Comparative | 100 | 50 | H₂SO₄ | 90/60 | Centrifuge | — | 5.00 |
| Example 10 | | | (96%) | | | | |
| | | | 0.32 g | | | | |
| Control D | 100 | — | — | — | — | — | — |
| | Ca | K | Mg | Na | S | P | % |
| | (ppm) | (ppm) | (ppm) | (ppm) | (ppm) | (ppm) | FFA |
| Example 16 | 8 | 1.3 | 0.5 | 10 | 37 | 23 | 0.40 |
| Comparative | 48 | 10 | 1.3 | 32 | 110 | 29 | 0.21 |
| Example 10 | | | | | | | |
| Control D | 150 | 55 | 14 | 150 | 27 | 190 | 4.09 |

Referring now to Table 5, Example 16 which utilizes MSA includes less phosphorous and a comparable amount of FFA to Comparative Example 10 which utilizes sulfuric acid. Further, Example 16 includes significantly reduced amounts of phosphorous and FFA when compared to undegummed Oil D (Control D), i.e., the oil of Example 16 is effectively degummed and esterified with the method of the subject disclosure.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described herein in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described within the scope of the appended claims.

1. A method for degumming and esterification of an oil comprising fatty acid glycerides, free fatty acids, and phospholipids, said method comprising the steps of:
mixing the oil, a C1 to C5 monohydric alcohol, and methanesulfonic acid to form a reaction mixture;
heating the reaction mixture to esterify the free fatty acids and produce a fatty acid alkylester and water, and to degum the phospholipids;
causing a phase separation between:
a first phase comprising the C1 to C5 monohydric alcohol, phosphorous compounds, and water,
a second phase comprising the fatty acid glycerides and the fatty acid alkylester, and
a residual solid phase; and
separating the second phase from the first phase and the residual solid phase.

2. A method as set forth in claim 1 wherein the oil is selected from algae 1, algae 2, babassu oil, beef tallow, borage oil, camelina oil, canola oil, carob seed oil, castor oil, choice white grease, coconut oil, coffee, corn oil, evening primrose oil, fish oil, hemp oil, hepar oil, jatropha oil, jojoba oil, karanja oil, lesquerella fendlari oil, linseed oil, moringa oleifera oil, mustard oil, neem oil, palm oil, palm kernel oil, peanut oil, perilla seed oil, poultry fat, rapeseed oil, rice bran oil, soybean oil, stillingia oil, sunflower oil, tung oil, used cooking oil, yellow grease, vegetable oil, and combinations thereof.

3. A method as set forth in claim 1 wherein the oil comprises greater than 0.5 percent by weight free fatty acids, based on the total weight of the oil.

4. A method as set forth in claim 1, wherein the reaction mixture is free of water.

5. A method as set forth in claim 1, wherein the step of heating is conducted in less than 180 minutes.

6. A method as set forth in claim 1, wherein the step of heating is conducted at a temperature of from 20 to 80° C.

7. A method as set forth in claim 1, wherein the step of heating is further defined as refluxing.

8. A method as set forth in claim 1, wherein the fatty acid alkylester comprises a fatty acid methylester.

9. A method as set forth in claim 1, wherein the step of causing a phase separation is conducted via centrifugation.

10. A method as set forth in claim 9 wherein the centrifugation is conducted in less than 120 minutes.

11. A method as set forth in claim 1, wherein the oil is present in the reaction mixture in an amount of from 50 to 95 percent by weight based on the total weight of the reaction mixture, the C1 to C5 monohydric alcohol is present in the reaction mixture in an amount of from 5 to 50 percent by weight based on the total weight of the reaction mixture, and/or the methanesulfonic acid is present in the reaction mixture in an amount of from 0.1 to 3 percent by weight based on the total weight of the reaction mixture.

12. A method as set forth in claim 1, wherein the second phase comprises less than 60 percent by weight of the total weight of FFA originally present in the oil and/or the second phase comprises less than 60 percent by weight of the total weight of the phosphorous originally present in the oil.

13. A method as set forth in claim 1, further comprising the additional steps of:
mixing the separated second phase, the C1 to C5 monohydric alcohol, and methanesulfonic acid to form a second reaction mixture;
heating the second reaction mixture to esterify the remaining free fatty acids and to produce the fatty acid alkylester and water, and to degum the remaining phospholipids;
causing a phase separation between:
a third phase comprising the C1 to C5 monohydric alcohol, phosphorous compounds, and water; and
a fourth phase comprising the fatty acid glycerides and the fatty acid alkylester, and
a second residual solid phase; and
separating the third phase from the fourth phase.

14. A method as set forth in claim 1, further comprising the steps of:
transesterifying the second phase or the fourth phase with the C1 to C5 monohydric alcohol in the presence of at least one basic catalyst to form a transesterification mixture comprising a fatty acid alkylester and glycerine; and
treating the transesterification mixture with sulfuric and/or methanesulfonic acid.

15. A method as set forth in claim 14 further including the step of phase separating the fatty acid alkylester and the glycerine subsequent to the step of transesterifying, but prior to the step of treating the transesterification mixture with sulfuric or methanesulfonic acid.

16. A method as set forth in claim 14 wherein the basic catalyst is at least one basic alkali metal or alkaline earth metal compound selected from the group of sodium hydroxide, potassium hydroxide, a sodium alkoxide of the short-chain monohydric alcohol having 1 to 5 carbon atoms, a potassium alkoxide of the short-chain monohydric alcohol having 1 to 5 carbon atoms, and combinations thereof.

17. A method as set forth in claim 1, wherein the C1 to C5 monohydric alcohol is methanol or ethanol.

18. A method as set forth in claim 1, wherein the methanesulfonic acid is formed by an air oxidation process.

19. A method as set forth in claim 1 further comprising the step of washing the second phase with water having a temperature of from 20 to 50° C.

20. A method as set forth in claim 1 wherein the second phase comprises less than 20 percent by weight of the total weight of free fatty acids which were originally present in the oil and less than 20 percent by weight of the total weight of phosphorous which was originally present in the oil.
